(19) United States
(12) Patent Application Publication
(10) Pub. No.: US 2014/0049849 A1
(43) Pub. Date: Feb. 20, 2014

(54) LENS UNIT AND IMAGE CAPTURING APPARATUS

(71) Applicant: NIKON CORPORATION, Tokyo (JP)

(72) Inventors: Hosei NAKAHIRA, Tokyo (JP); Toshihisa TANAKA, Yokohama-shi (JP); Yoichi YAMAMOTO, Tokyo (JP)

(73) Assignee: NIKON CORPORATION, Tokyo (JP)

(21) Appl. No.: 14/062,294

(22) Filed: Oct. 24, 2013

Related U.S. Application Data
(63) Continuation of application No. 13/308,916, filed on Dec. 1, 2011.
Application No. 13/308,916 is a continuation of application No. PCT/JP2010/003742, filed on Jun. 4, 2010.

(30) Foreign Application Priority Data
Jun. 4, 2009 (JP) 2009-135474
Jun. 4, 2009 (JP) 2009-135496

(51) Int. Cl. G02B 7/04

(52) U.S. Cl. CPC G02B 7/04
USPC 359/824; 359/823

(57) ABSTRACT

Provided is a lens unit comprising an actuator that is self-supporting when at a stopped position. The lens unit comprises a holding frame that holds a lens; a movement actuator that moves the holding frame, which is connected to a moving member that moves linearly relative to a stator, when drive force is generated, and does not prevent the moving member from moving relative to the stator when the moving member is stopped; and a braking actuator that stops the moving member from moving relative to the stator, using frictional force, when the movement actuator is not generating the drive force, and decreases the frictional force when the movement actuator generates the drive force.

This is Continuation of application Ser. No. 13/308,916 which was filed on Dec. 1, 2011. The contents of the following Japanese patent applications are incorporated herein by reference: No. 2009-135474 filed on Jun. 4, 2009, and No. 2009-135496 filed on Jun. 4, 2009. The contents of the following International patent application are incorporated herein by reference: PCT/JP2010/003742 filed on Jun. 4, 2010.

### BACKGROUND

1. Technical Field

The present invention relates to a lens unit and an image capturing apparatus.

2. Related Art

In an optical system of an image capturing apparatus, a linear actuator is used as one type of drive source for moving the optical components. A linear actuator can be formed by arranging one of coils and a permanent magnet on a stator in a line and mounting the other of the coils and the permanent magnet on a moving member that moves along the stator, as described in Japanese Patent Application Publication No. 2004-191453, for example.

In a linear actuator, the moving member has a structure enabling smooth movement. Therefore, when the moving member is stopped, power is consumed in order to hold the moving member at the stopped position using feedback control based on the position of the moving member, for example. Furthermore, when the power supply is cut off, the linear actuator cannot maintain the position of the moving member.

### SUMMARY

In order to solve the above problems, according to a first aspect related to the innovations herein, provided is a lens unit comprises a holding frame that holds a lens; a movement actuator that moves the holding frame, which is connected to a moving member that moves linearly relative to a stator, when drive force is generated, and does not prevent the moving member from moving relative to the stator when the moving member is stopped; and a braking actuator that stops the moving member from moving relative to the stator, using frictional force, when the movement actuator is not generating the drive force, and decreases the frictional force when the movement actuator generates the drive force.

According to a second aspect related to the innovations herein, provided is an image capturing apparatus comprising the lens unit.

The summary clause does not necessarily describe all necessary features of the embodiments of the present invention. The present invention may also be a sub-combination of the features described above.

### BRIEF DESCRIPTION OF THE DRAWINGS

FIG. 1 is a schematic cross-sectional view of the overall image capturing apparatus 99.

FIG. 2 is a perspective view of the linear movement drive section 300.

FIG. 3 is a cross-sectional view of the linear movement drive section 300.

FIG. 4 is a cross-sectional view of the linear movement drive section 300 during operation.

FIG. 5 is a perspective view of most of the configuration of the stator 120.

FIG. 6 is a schematic view of the electrical configuration of the linear movement drive section 300.

FIG. 7 is a block diagram of the control system 301 of the linear movement drive section 300.

FIG. 8 shows another configuration of the lens unit 100.

FIG. 9 shows yet another configuration of the lens unit 100.

FIG. 10 is a schematic cross-sectional view of another image capturing apparatus 499.

FIG. 11 is a perspective view of the linear movement drive section 700.

FIG. 12 is a cross-sectional view of the linear movement drive section 700.

FIG. 13 is a perspective view of most of the configuration of the stator 520.

FIG. 14 is a schematic view of the electrical configuration of the linear movement drive section 700.

FIG. 15 is a block diagram of the control system 701 of the linear movement drive section 700.

FIG. 16 shows another configuration of the lens unit 500.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

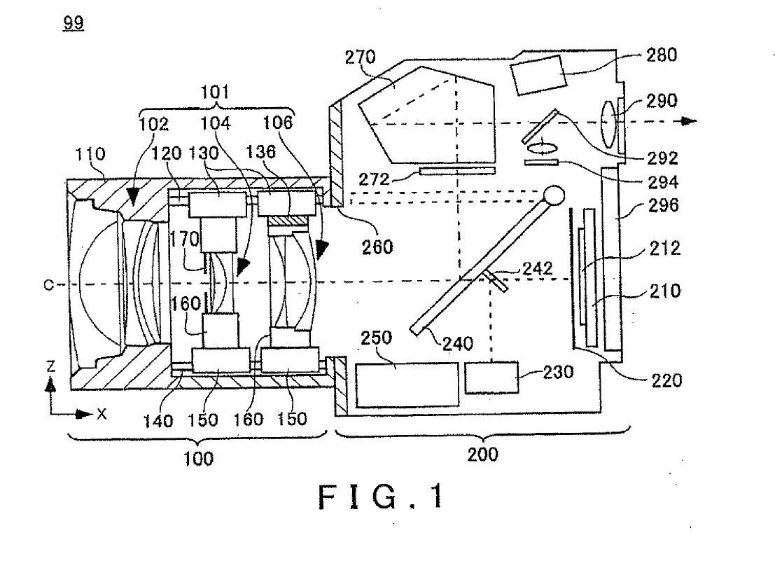

FIG. 1 is a schematic cross-sectional view of an overall configuration of an image capturing apparatus 99. The image capturing apparatus 99 is formed by combining a lens unit 100 and an image capturing section 200.

The lens unit 100 includes a lens barrel 110, a stator 120, a moving member 130, a guide axle 140, a guided portion 150, a holding frame 160, a diaphragm apparatus 170, and a plurality of lens groups 102, 104, and 106. The lens groups 102, 104, and 106 are arranged on a common optical axis C, thereby forming an optical system 101.

The lens barrel 110 is formed integrally with the image capturing section 200 by being connected to a mount section 260 of the image capturing section 200, which is described further below. The stator 120 and the guide axle 140, which are shaped as axles, are fixed within the lens barrel 110 to be parallel to each other and oriented in the longitudinal direction of the lens barrel 110.

The lens groups 102, 104, and 106 are each held independently by the holding frame 160. The holding frame 160 holds the lens group 104 and the diaphragm apparatus 170.

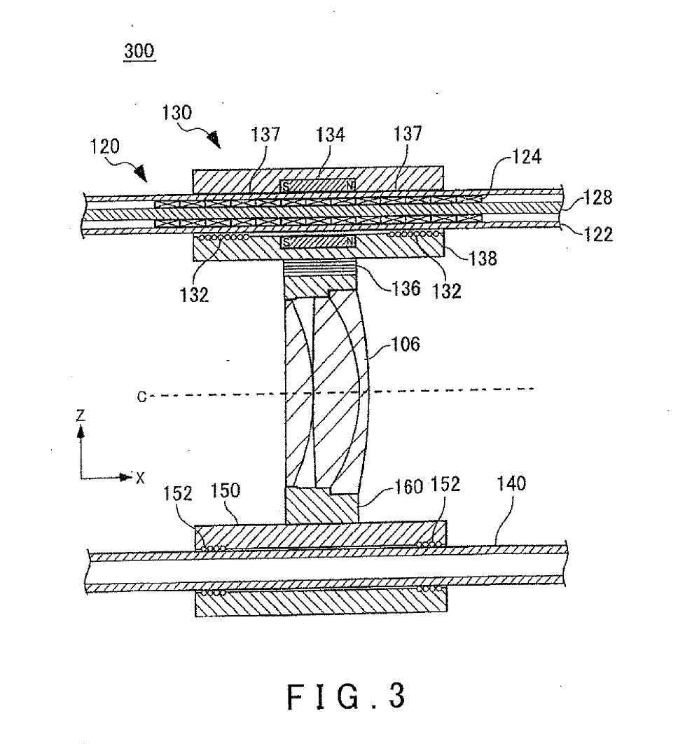

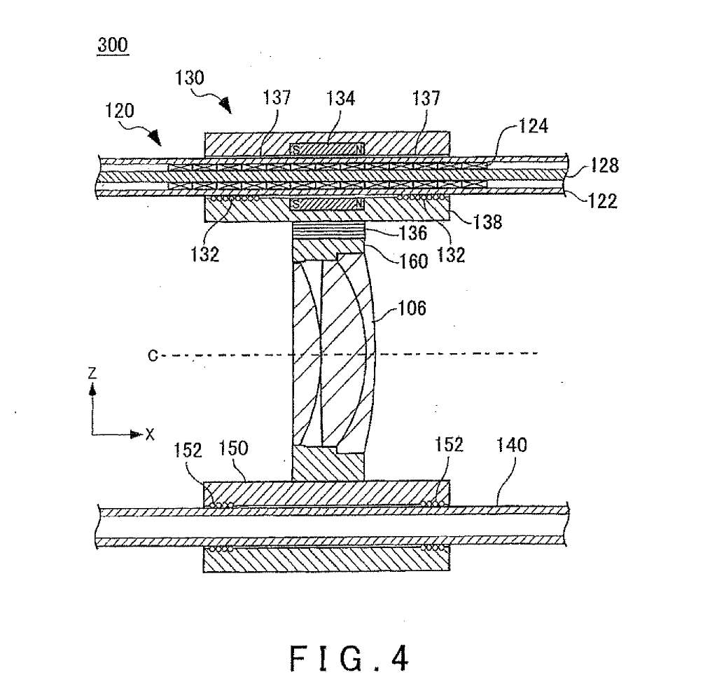

All or a portion of the holding frame 160 is supported to be moveable in the longitudinal direction of the lens barrel 110 from the stator 120 and the guide axle 140, via the moving member 130, the braking actuator 136, and the guided portion 150. The focal distance and focal position of the optical system 101 can be adjusted by moving the lens groups 102, 104, and 106. The braking actuator 136 is described in detail in relation to FIGS. 3 and 4.

The image capturing section 200 includes an optical system having a main mirror 240, a secondary mirror 242, a pentaprism 270, and an ocular optical system 290, and a control system having a focal point detecting section 230, a main control section 250, and a photometric unit 280. The main mirror 240 moves between a standby position, in which the main mirror 240 is oriented diagonally in the optical path of incident light through the optical system 101 of the lens unit 100, and an image capture position, which is shown by the dotted line in FIG. 1 and in which the main mirror 240 is raised out of the optical path of the incident light.

A secondary mirror 242 is disposed on the back surface of the main mirror 240 in the standby position. The secondary mirror 242 guides a portion of the incident light passing through the main mirror 240 to the focal point detecting section 230 positioned therebelow. Therefore, when the main mirror 240 is in the standby position, the focal point detecting section 230 detects a focal state of the optical system 101. When the main mirror 240 moves to the image capture position, the secondary mirror 242 also moves out of the optical path of the incident light.

When in the standby position, the main mirror 240 is inclined relative to the incident light and guides a majority of the incident light to a focusing screen 272 arranged thereabove. The focusing screen 272 is arranged at the focal position of the optical system 101, and displays the image formed by the optical system 101.

The image formed by the focusing screen 272 can be seen from the ocular optical system 290 via the pentaprism 270. Therefore, the image on the focusing screen 272 can be seen as a normal image from the ocular optical system 290.

A half mirror 292 is arranged between the pentaprism 270 and the ocular optical system 290. The half mirror 292 superimposes the display image formed by the finder LCD 294 onto the image of the focusing screen 272. As a result, the image seen at the output end of the ocular optical system 290 is a combination of the image of the focusing screen 272 and the image of the finder LCD 294. The finder LCD 294 displays information concerning image capturing conditions, setting conditions, and the like of the image capturing apparatus 99.

A portion of the light output from the pentaprism 270 is guided to the photometric unit 280. The photometric unit 280 measures the intensity of the incident light and a distribution or the like thereof, and these measurement results are referenced when determining the image capturing conditions.

The image capturing section 200 includes a shutter 220, an optical filter 212, and an image capturing element 210 that are arranged in the stated order on the optical axis C behind the main mirror 240 in a direction of the incident light from the lens unit 100. When the release switch of the image capturing section 200 is pressed, the main mirror 240 moves to the image capture position, and so the incident light is directed toward the shutter 220. When the shutter 220 is opened, the incident light progresses to be incident to the image capturing element 210. As a result, the image formed by the optical system 101 is converted into an electrical signal by the image capturing element 210.

The image capturing section 200 is provided with a main LCD 296 facing away from the lens unit 100. The main LCD 296 displays various types of setting information concerning the image capturing section 200, and can also display the image formed by the image capturing element 210 when the main mirror 240 is in the image capture position. Furthermore, the main LCD 296 may be used when showing the images generated by the image capturing element 210.

The main control section 250 performs overall control of the various operations described above. Furthermore, the main control section 250 controls an auto-focus mechanism that drives the lens unit 100 while referencing information concerning the distance to a subject as detected by the focal point detecting section 230 of the image capturing section 200.

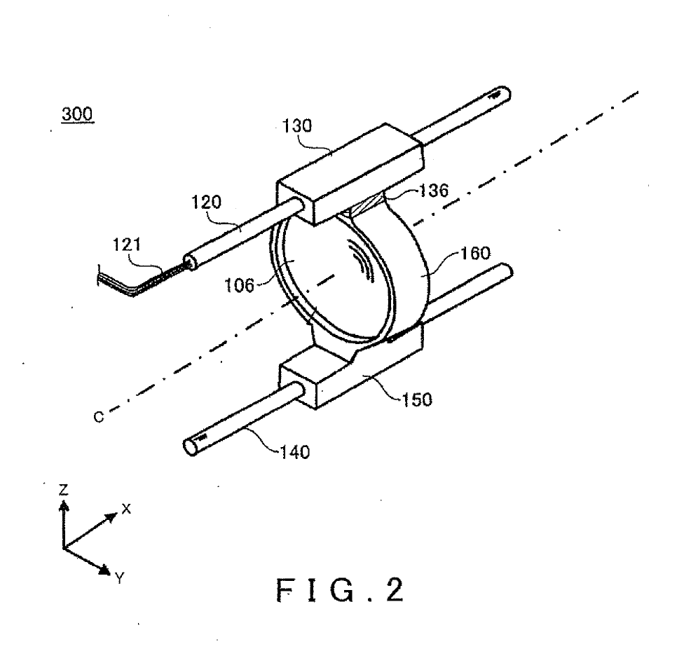

FIG. 2 is a perspective view of a linear movement drive section 300 in the lens unit 100. FIG. 2 shows one lens group 106 and the components for driving the holding frame 160 holding the lens group 106 extracted from the lens unit 100. In FIG. 2, components that are the same as components in FIG. 1 are given the same reference numerals, and redundant descriptions are omitted.

In the linear movement drive section 300, the holding frame 160 holding the lens group 106 is supported by the moving member 130 and the guided portion 150, which are formed integrally at symmetrically opposite positions on a frame having a substantially circular shape. The moving member 130 couples with the holding frame 160 via the braking actuator 136. The stator 120 is inserted into the moving member 130, and the moving member 130 moves in the direction in which the stator 120 extends. The guide axle 140 is inserted into the guided portion 150, and the guided portion 150 moves along the guide axle 140.

The drive force that moves the holding frame 160 is generated between the stator 120 and the moving member 130, as will be described further below. Therefore, a cable 121 that supplies power is coupled to the stator 120.

The holding frame 160 and the guided portion 150 move together with the moving member 130. The stator 120 and the guide axle 140 are arranged parallel to the optical axis C of the optical system 101, and therefore the lens group 106 held by the holding frame 160 moves along the optical axis C.

FIG. 3 is a cross-sectional view of the linear movement drive section 300. FIG. 3 shows the linear movement drive section 300 when the moving member 130 is not moving.

The stator 120 includes an outer barrel 122, a core 128, and a plurality of coils 124. The moving member 130 includes a moving member body 138, and also a bearing 132, a permanent magnet 134, and a braking actuator 136 that are attached to the moving member body 138.

In the stator 120, the outer barrel 122 and the core 128 are arranged to be coaxial. Each coil 124 is wrapped around the core 128 inside the outer barrel 122, and the coils 124 are arranged in the longitudinal direction of the stator 120. In order to improve the control of the linear movement drive section 300, the outer barrel 122 and the core 128 are preferably non-magnetic.

In the moving member 130, the moving member body 138 has an inner diameter that is greater than the outer diameter of the stator 120. A bearing 132 is disposed on the inner surface of the moving member 130 that is toward the bottom of FIG. 3, and in the state shown in FIG. 3, the bottom inner surface of the moving member 130 is separated from the stator 120. On the other hand, the top inner surface of the moving member 130 serves as a braking surface 137 that contacts the top surface of the stator 120. As a result, movement of the moving member 130 relative to the stator 120 can be stopped.

The guided portion 150 has an inner diameter that is greater than the outer diameter of the guide axle 140, and the inner surface of the guided portion 150 is distanced from the surface of the guide axle 140. A pair of bearings 152 are disposed on the inner surface at each end of the guided portion 150, and the guided portion 150 is supported by the guide axle 140 via the bearings 152. Therefore, the guided portion 150 can slide along the guide axle 140.

The permanent magnet 134 is shaped as a ring that surrounds the stator 120 in the middle of the moving member body 138. The permanent magnet 134 is magnetized such that the polarity is inverted at the ends thereof in the longitudinal direction of the stator 120. However, the magnetism of the permanent magnet 134 is not particularly limited, and the permanent magnet 134 may be arranged to have a polarity in the longitudinal direction of the stator 120 that is opposite the polarity shown in FIG. 3.

The top surface of the braking actuator 136 is coupled to the bottom surface of the moving member body 138, and the bottom surface of the braking actuator 136 is coupled to the holding frame 160. As a result, the holding frame 160 is connected to the moving member body 138. When the braking actuator 136 operates according to a drive voltage supplied from the outside, the thickness of the braking actuator 136 increases, and the resulting state is shown in FIG. 4.

In this way, when the braking actuator 136 is not operating, the moving member body 138 contacts the stator 120 and the resulting frictional force holds the moving member 130 in place. Accordingly, the holding frame 160 and the lens group 106 held by the holding frame 160 are held in place relative to the stator 120.

The braking actuator 136 is formed of a piezoelectric element whose thickness changes when voltage is applied thereto. In other words, a piezoelectric element is used to form the braking actuator 136 with a thickness that decreases when a drive voltage is applied thereto. As a result, when the linear movement drive section 300 is not driving the moving member 130, the linear movement drive section 300 is in the state shown in FIG. 4.

FIG. 4 is a cross-sectional view of the linear movement drive section 300 during operation. When the linear movement drive section 300 operates, the drive voltage is applied to the braking actuator 136 as well. Therefore, the thickness, i.e. height, of the braking actuator 136 increases and the moving member body 138 is raised upward, i.e. toward the top of FIG. 4.

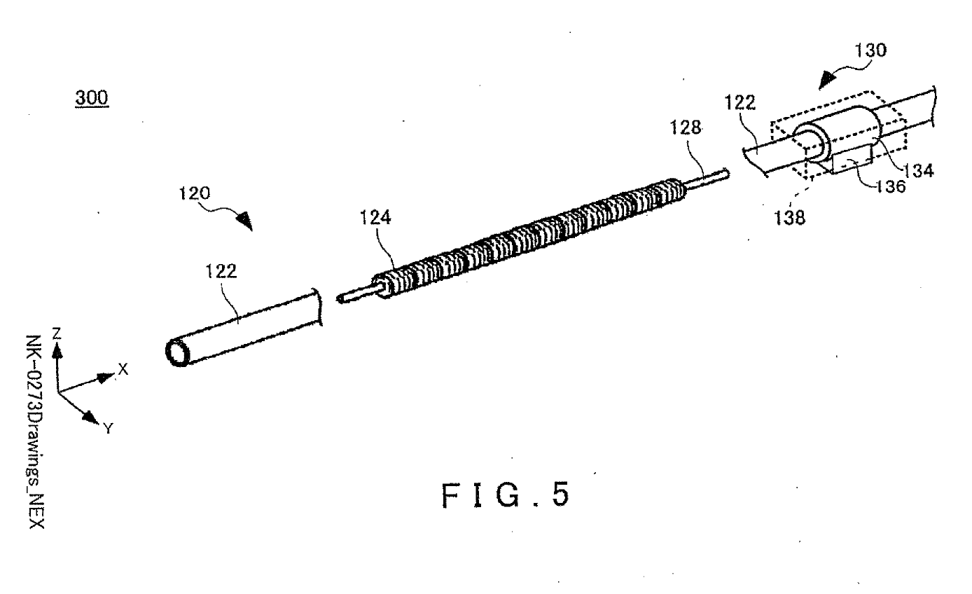

As a result, as shown in FIG. 4, the braking surface 137 of the moving member body 138 is moved away from the surface of the stator 120. Furthermore, the bearing 132 of the moving member body 138 contacts the stator 120. The bearing 132 decreases the sliding resistance between the moving member body 138 and the stator 120, and so the moving member 130 can move smoothly on the stator 120. The driving of the moving member 130 relative to the stator 120 is described further below in relation to FIGS. 5 to 7.

The braking actuator 136 operating as described above can be formed of a bimetal that is deformed when heated. As another example, the braking actuator 136 can be formed of a shape memory alloy that returns to the remembered shape when heated to a transition temperature.

The bimetal or shape memory alloy can be combined with a heater, for example, and controlled by turning the power supply ON and OFF. By transferring the heat generated by the coils 124 in the stator 120 to the braking actuator 136, the operation of the linear movement drive section 300 is automatically performed simultaneously with the releasing of the brake on the moving member 130 by the braking actuator 136.

In the above example, one end of the holding frame 160 is driven by the moving member 130 and the other end serves as the guided portion 150 that follows on the moving member 130. However, a pair of moving members 130 may be provided such that the holding frame 160 is driven simultaneously at both ends. In this case, it is obvious that a stator 120 is used in place of the guide axle 140.

FIG. 5 is a perspective view of the linear movement drive section 300, in which the internal structures of the stator 120 and the moving member 130 are exposed. Components that are the same as components shown in FIGS. 1 to 3 are given the same reference numerals, and redundant descriptions are omitted.

The stator 120 includes the plurality of coils 124 arranged along the core 128. Each coil 124 independently generates a magnetic field when a drive current is applied thereto. In the moving member 130, the permanent magnet 134 surrounds the coils 124 from the outer surface of the outer barrel 122. Furthermore, in the moving member 130, the braking actuator 136 is arranged on the outer surface of the moving member 130 in the radial direction of the stator 120 and the moving member 130.

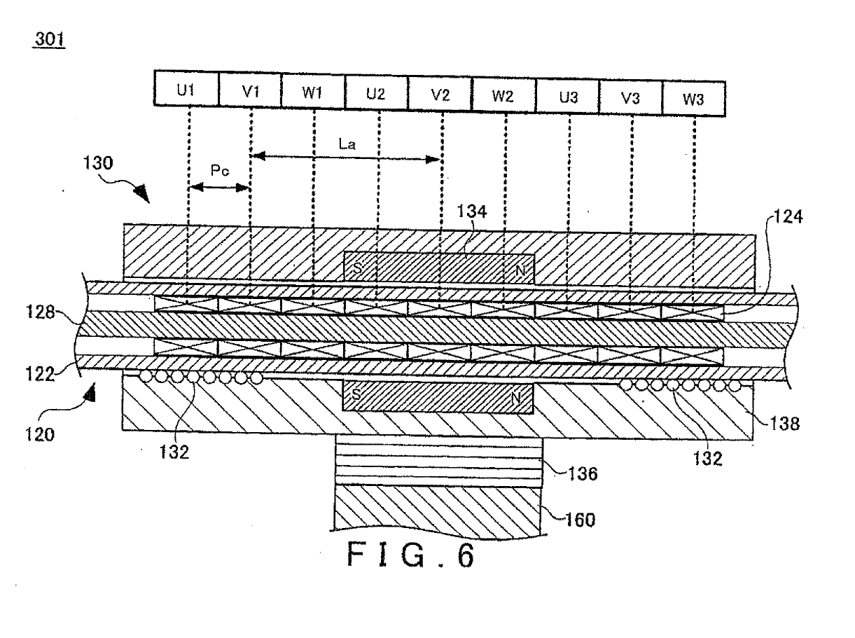

FIG. 6 is a schematic view of the electrical configuration of the linear movement drive section 300. Components that are the same as components shown in other Figures are given the same reference numerals, and redundant descriptions are omitted.

Each coil 24 is independently wrapped around the core 128, and as shown by the dotted lines in FIG. 6, three phases (U, V, and W) are created. In this example, the three phases U, V, and W are used, but it is obvious that the configuration is not limited to three phases, and these phases can be set according to the desired distance over which the moving member 130 is to move. The connections of the coils 124 are not limited to three phases of connections, and the number of phase connections may be two, or greater than three.

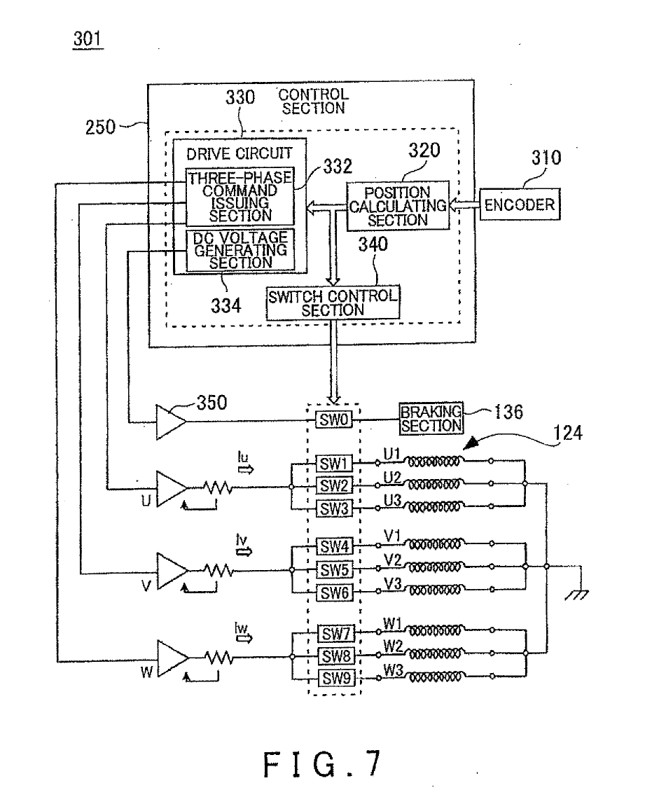

FIG. 7 is a block diagram showing the control system 301 of the linear movement drive section 300. The control system 301 includes a position calculating section 320, a drive circuit 330, and a switch control section 340. The control system 301 is included in the control section 250 of the image capturing section 200.

The position calculating section 320 references the position of the moving member 130 detected by the encoder 310 disposed in the linear movement drive section 300, and turns ON the drive circuit 330 when moving the moving member 130. The drive circuit 330 includes a three-phase command issuing section 332 and a DC voltage generating section 334. The three-phase command issuing section 332 generates a drive current to be supplied to the coils 124. The DC voltage generating section 334 generates the drive voltage to be applied to the braking actuator 136. The switch control section 340 couples the three-phase command issuing section 332 and the DC voltage generating section 334 to the coils 124 or the braking actuator 136 in response to instructions from the position calculating section 320.

When the switch SW0 is connected, the drive voltage of the braking actuator 136 is applied to the braking actuator 136 via the amplifier 350. As a result, the thickness of the braking actuator 136 increases and the moving member body 138 moves in the radial direction of the stator 120. Therefore, the braking surface 137 moves away from the stator 120, and the moving member body 138 contacts the stator 120 via the bearing 132. Accordingly, the moving member 130 can move smoothly along the stator 120.

Concerning the drive current supplied to the coils 124, when the control section 250 indicates a target position for the moving member 130, the position calculating section 320 references the encoder 310 and calculates a drive amount for the linear movement drive section 300 corresponding to the direction and distance to the target position. The three-phase command issuing section 332 generates the drive current for each of the U-phase, the V-phase, and the W-phase, according to the calculation results, and supplies a three-phase command value to the corresponding current amplifiers.

The switch control section 340 turns a plurality of switches SW1 to SW9 of the switching section S ON and OFF according to the calculation results of the position calculating section 320. In this way, the linear movement drive section 300 can be operated by causing currents Iu, Iv, or Iw to flow through the coils 124. The current amplifiers may be provided with serial resistors that sense excessive current, in order to protect against excessive current.

The supply schedule of the drive current to the coils 124 is shown below in Table 1. In Table 1, a switch number for the switches SW1 to SW9 corresponding to the coils 124 is recorded in each row, and a distance in millimeters to the target position of the moving element is recorded in each column. Furthermore, each ◯ mark in Table 1 indicates that the corresponding coil is being powered, and each × mark indicates that the corresponding coil is not being powered. The numerical value for the magnet position indicates the length of one coil 124, in millimeters, in the movement direction of the moving member 130. Each coil 124 has a length of 10 millimeters.

TABLE 1

| | | MOVING MEMBER POSITION 124 La (mm) | | | | | | |
|---|---|---|---|---|---|---|---|---|
| | | −35 | −25 | −15 | −5 | 5 | 15 | 25 |
| COIL | | TO | TO | TO | TO | TO | TO | TO |
| 124 | SW | −25 | −15 | −5 | 5 | 15 | 25 | 35 |
| U1 | SW1 | ◯ | X | X | X | X | X | X |
| V1 | SW4 | ◯ | ◯ | X | X | X | X | X |
| W1 | SW7 | ◯ | ◯ | ◯ | X | X | X | X |
| U2 | SW2 | X | ◯ | ◯ | ◯ | X | X | X |
| V2 | SW5 | X | X | ◯ | ◯ | ◯ | X | X |
| W2 | SW8 | X | X | X | ◯ | ◯ | ◯ | X |
| U3 | SW3 | X | X | X | X | ◯ | ◯ | ◯ |
| V3 | SW6 | X | X | X | X | X | ◯ | ◯ |
| W3 | SW9 | X | X | X | X | X | X | ◯ |

By sequentially supplying the drive current to the coils 124 in this way, the moving member 130 on which the permanent magnet 134 is mounted can be moved. Furthermore, by supplying the drive current to the coil 124 in the reverse order, the movement direction of the moving member 130 can be reversed.

Furthermore, while the drive current is being supplied to one of the coils 124, the braking actuator 136 does not perform braking of the moving member 130. Therefore, the moving member 130 receiving this drive force can slide, thereby moving the holding frame 160.

When none of the coils 124 are supplied with the drive current, the switch control section 340 causes all of the switches SW1 to SW9, but not the switch SW0, to be in the connected state. As a result, the linear movement drive section 300 enters a coil short mode, and the linear movement drive section 300 is stopped by the counter electromotive current generated by the relative movement of the permanent magnet 134 and the coils 124.

Furthermore, when none of the coils 124 are supplied with the drive current, the drive voltage is not supplied to the braking actuator 136. As a result, the braking actuator 136 moves the moving member body 138 such that the bearing 132 is moved away from the stator 120, the braking surface 137 contacts the stator 120, and the movement of the moving member 130 is stopped by the stator 120.

This braking is maintained without drive power being received from the outside, and therefore the position at which the moving member 130 is stopped is maintained regardless of whether the power supply is ON or OFF. Furthermore, no power is consumed by stopping the moving member 130.

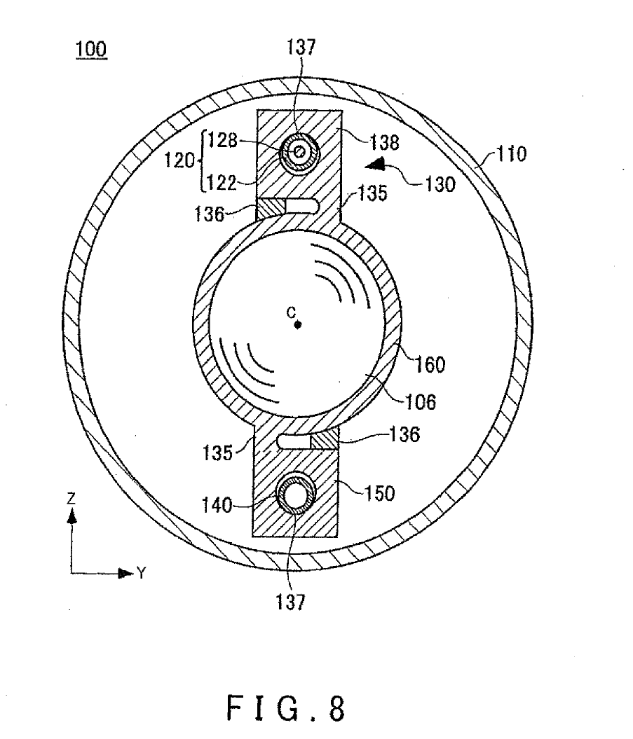

FIG. 8 shows another configuration of the lens unit 100. Components that are the same as components shown in other Figures are given the same reference numerals, and redundant descriptions are omitted. Furthermore, aside from the portion described below, this lens unit 100 has the same configuration as the embodiment shown in FIGS. 1 to 7.

In the lens unit 100, the moving member body 138 and the guided portion 150 are each supported by the holding frame 160 via a hinge portion 135. One end of each hinge portion 135 is formed integrally with the outer surface of the holding frame 160, and the other end is formed integrally with the corresponding moving member body 138 or guided portion 150.

Each hinge portion 135 biases the corresponding moving member body 138 or guided portion 150 toward the optical axis C of the lens group 106. As a result, the braking surface 137 of the moving member body 138 generates a braking force by being pressed against the stator 120. Furthermore, the braking surface 137 on the inner surface of the guided portion 150 contacts the guide axle 140. As a result, the braking force is further increased, and the lens group 106 can be reliably held in position.

A pair of braking actuators 136 are disposed respectively between the holding frame 160 and the moving member body 138 and between the holding frame 160 and the guided portion 150. When operating, each braking actuator 136 causes the corresponding moving member body 138 or guided portion 150 to move away from the optical axis of the lens group 106. Accordingly, when the braking actuators 136 operate, the braking surfaces 137 of the moving member body 138 and the guided portion 150 move away from the stator 120 and the guide axle 140, and the braking force of the braking surfaces 137 is thereby removed.

As a result, the moving member body 138 and the guided portion 150 are able to slide along the stator 120 and the guide axle 140. With the operation described above, the bearing 152 on the inner surface of the guided portion 150 further from the optical axis C is omitted. With this configuration, the positions of the moving member body 138 and the guided portion 150 are fixed relative to the holding frame 160 by the hinge portions 135, and therefore remain in the same positions regardless of deformation of the braking actuators 136.

Furthermore, the hinge portions 135 are disposed to be symmetrically opposite each other with respect to the optical axis C of the lens group 106. The movement of the hinge portions 135 when the braking actuators 136 operate is also symmetric with respect to the optical axis C. Therefore, the optical axis C does not move no matter the operational state of the braking actuators 136, and so the optical performance of the lens unit 100 can be ensured.

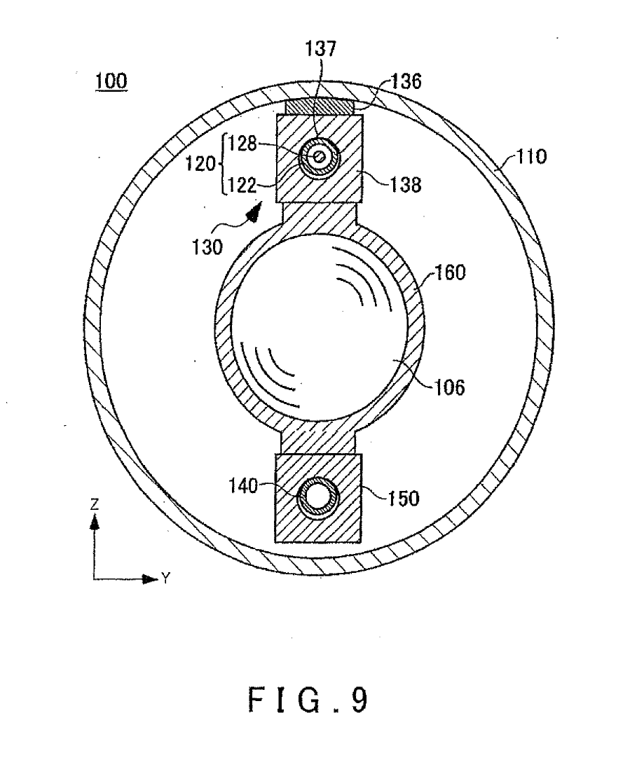

FIG. 9 is a cross-sectional view of another configuration of the lens unit 100. FIG. 9 shows a cross-sectional plane orthogonal to the optical axis C. In FIG. 9, components that are the same as components shown in other Figures are given the same reference numerals, and redundant descriptions are omitted. This lens unit 100 has a unique configuration in which the braking actuator 136 is arranged between the moving member body 138 and the lens barrel 110 of the lens unit 100.

The braking actuator 136 is the same as the braking actuator 136 described in relation to FIG. 3, and when a drive voltage is not supplied thereto, one surface of the braking actuator 136 is fixed on the moving member body 138 and the other surface presses against the inner surface of the lens barrel 110. As a result, the moving member body 138 is pressed down, and the braking surface 137 is pressed against the stator 120. Accordingly, the moving member 130 is prevented from moving relative to the stator 120.

When the moving member 130 is to be moved relative to the stator 120, the braking actuator 136 is driven such that the thickness thereof decreases in the radial direction of the lens barrel 110. As a result, the moving member 130 is no longer prevented from moving relative to the lens barrel 110, and can slide along the stator 120 or the guide axle 140.

A piezoelectric element, bimetal, or a shape memory alloy may be used for the braking actuator 136, in the same manner as in the other embodiments. Furthermore, aside from the arrangement of the braking actuator 136, the configurations of the stator 120 and the moving member 130 are the same as in the other embodiments.

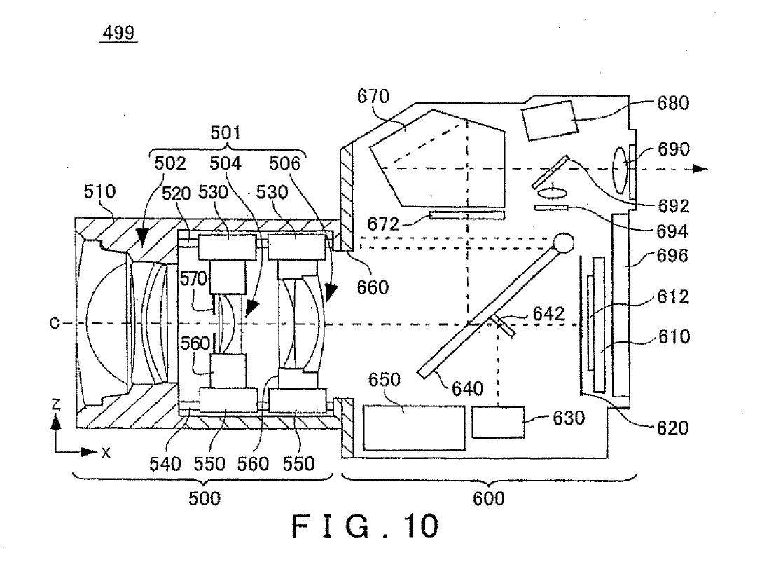

FIG. 10 is a schematic cross-sectional view of the overall configuration of another image capturing apparatus 499. The image capturing apparatus 499 is formed by combining a lens unit 500 and an image capturing section 600.

The lens unit 500 includes a lens barrel 510, a stator 520, a moving member 530, a guide axle 540, a guided portion 550, a holding frame 560, a diaphragm apparatus 570, and a plurality of lens groups 502, 504, and 506. The lens groups 502, 504, and 506 are arranged on a common optical axis C, thereby forming an optical system 501.

The lens barrel 510 is formed integrally with the image capturing section 600 by being connected to a mount section 660 of the image capturing section 600, which is described further below. The stator 520 and the guide axle 540, which are shaped as axles, are fixed within the lens barrel 510 to be parallel to each other and oriented in the longitudinal direction of the lens barrel 510.

The lens groups 502, 504, and 506 are each held independently by the holding frame 560. The lens group 504 is held by both the holding frame 560 and the diaphragm apparatus 570. All or a portion of the holding frame 560 is supported to be moveable in the longitudinal direction of the lens barrel 510 from the stator 520 and the guide axle 540, via the moving member 530 or the guided portion 550. The focal distance and focal position of the optical system 501 can be adjusted by moving the lens groups 502, 504, and 506.

The image capturing section 600 includes an optical system having a main mirror 640, a secondary mirror 642, a pentaprism 670, and an ocular optical system 690, and a control system having a focal point detecting section 630, a main control section 650, and a photometric unit 680. The main mirror 640 moves between a standby position, in which the main mirror 640 is oriented diagonally in the optical path of incident light through the optical system 501 of the lens unit 500, and an image capture position, which is shown by the dotted line in FIG. 10 and in which the main mirror 640 is raised out of the optical path of the incident light.

A secondary mirror 642 is disposed on the back surface of the main mirror 640 in the standby position. The secondary mirror 642 guides a portion of the incident light passing through the main mirror 640 to a focal point detecting section 630 positioned therebelow. Therefore, when the main mirror 640 is in the standby position, the focal point detecting section 630 detects a focal state of the optical system 501. When the main mirror 640 moves to the image capture position, the secondary mirror 642 also moves out of the optical path of the incident light.

When in the standby position, the main mirror 640 is inclined relative to the incident light and guides a majority of the incident light to a focusing screen 672 arranged thereabove. The focusing screen 672 is arranged at the focal position of the optical system 501, and displays the image formed by the optical system 501.

The image formed by the focusing screen 672 can be seen from the ocular optical system 690 via the pentaprism 670. Therefore, the image on the focusing screen 672 can be seen as a normal image from the ocular optical system 690.

A half mirror 692 is arranged between the pentaprism 670 and the ocular optical system 690. The half mirror 692 superimposes the display image formed by the finder LCD 694 onto the image of the focusing screen 672. As a result, the image seen at the output end of the ocular optical system 690 is a combination of the image of the focusing screen 672 and the image of the finder LCD 694. The finder LCD 694 displays information concerning image capturing conditions, setting conditions, and the like of the image capturing apparatus 499.

A portion of the light output from the pentaprism 670 is guided to the photometric unit 680. The photometric unit 680 measures the intensity of the incident light and a distribution or the like thereof, and these measurement results are referenced when determining the image capturing conditions.

In the image capturing section 600, a shutter 620, an optical filter 612, and an image capturing element 610 are arranged in the stated order on the optical axis C behind the main mirror 640 in a direction of the incident light from the lens unit 500. When the release switch of the image capturing section 600 is pressed, the main mirror 640 moves to the image capture position, and so the incident light is directed toward the shutter 620. When the shutter 620 is opened, the incident light progresses to be incident to the image capturing element 610. As a result, the image formed by the optical system 501 is converted into an electrical signal by the image capturing element 610.

The image capturing section 600 is provided with a main LCD 696 facing away from the lens unit 500. The main LCD 696 displays various types of setting information concerning the image capturing section 600, and can also display the image formed by the image capturing element 610 when the main mirror 640 is in the image capture position. Furthermore, the main LCD 696 may be used when showing the images generated by the image capturing element 610.

The main control section 650 performs overall control of the various operations described above. Furthermore, the main control section 650 controls an auto-focus mechanism that drives the lens unit 500 while referencing information concerning the distance to a subject as detected by the focal point detecting section 630 of the image capturing section 600.

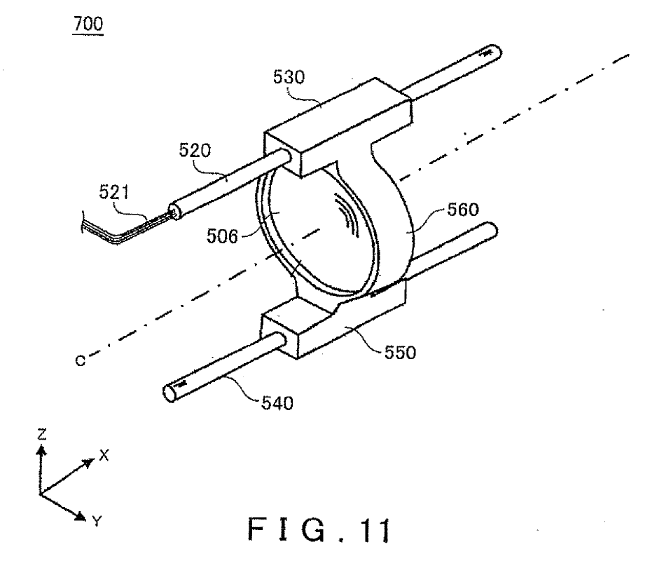

FIG. 11 is a perspective view of a linear movement drive section 700 in the lens unit 500. FIG. 11 shows one lens group 506 and the components for driving the holding frame 560 holding the lens group 506 extracted from the lens unit 500. In FIG. 11, components that are the same as components in FIG. 10 are given the same reference numerals, and redundant descriptions are omitted.

In the linear movement drive section 700, the holding frame 560 holding the lens group 506 is supported by the moving member 530 and the guided portion 550, which are formed integrally at symmetrically opposite positions on a frame having a substantially circular shape. The stator 520 is inserted into the moving member 530, and the moving member 530 moves in the direction in which the stator 520 extends. The guide axle 540 is inserted into the guided portion 550, and the guided portion 550 moves along the guide axle 540.

The drive force that moves the holding frame 560 is generated between the stator 520 and the moving member 530, as will be described further below. Therefore, a cable 521 that supplies power is coupled to the stator 520.

The holding frame 560 and the guided portion 550 move together with the moving member 530. The stator 520 and the guide axle 540 are arranged parallel to the optical axis C of the optical system 501, and therefore the lens group 506 held by the holding frame 560 moves along the optical axis C.

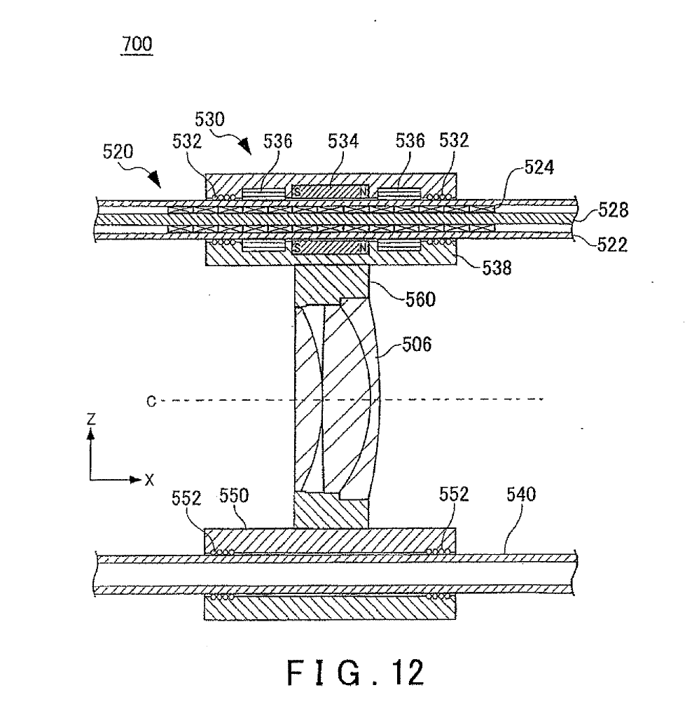

FIG. 12 is a cross-sectional view of the linear movement drive section 700. The stator 520 includes an outer barrel 522, a core 528, and a plurality of coils 524. The moving member 530 includes a moving member body 538, and also bearings 532, a permanent magnet 534, and braking actuators 536 that are attached to the moving member body 538.

In the stator 520, the outer barrel 522 and the core 528 are arranged to be coaxial. Each coil 524 is wrapped around the core 528 inside the outer barrel 522, and the coils 524 are arranged in the longitudinal direction of the stator 520. In order to improve the control of the linear movement drive section 700, the outer barrel 522 and the core 528 are preferably non-magnetic.

In the moving member 530, the moving member body 538 has an inner diameter that is greater than the outer diameter of the stator 520, and the inner surface of the moving member 530 is distanced from the stator 520. A pair of bearings 532 are disposed on the inner surface at each end of the moving member 530, and the moving member 530 is supported by the stator 520 via the bearings 532. Therefore, the moving member 530 can slide along the stator 520.

The guided portion 550 has an inner diameter that is greater than the outer diameter of the guide axle 540, and the inner surface of the guided portion 550 is distanced from the surface of the guide axle 540. A pair of bearings 552 are disposed on the inner surface at each end of the guided portion 550, and the guided portion 550 is supported by the guide axle 540 via the bearings 552. Therefore, the guided portion 550 can move smoothly along the guide axle 540.

The permanent magnet 534 is shaped as a ring that surrounds the stator 520 in the middle of the moving member body 538. The permanent magnet 534 is magnetized such that the polarity is inverted at the ends thereof in the longitudinal direction of the stator 520. However, the magnetism of the permanent magnet 534 is not particularly limited, and the permanent magnet 534 may be arranged to have a polarity in the longitudinal direction of the stator 520 that is opposite the polarity shown in FIG. 12.

The top surface of each braking actuator 536 is coupled to the bottom surface of the moving member body 538, and the bottom surface of each braking actuator 536 contacts the outer surface of the stator 520. As a result, the surfaces of the braking actuators 536 serve as braking sections, and the frictional force generated thereby fixes the moving member 530 relative to the stator 520.

The thickness of each braking actuator 536 decreases when operating according to control from the outside. Therefore, one surface of each braking actuator 536 moves away from the surface of the stator 520, and so the braking actuators 536 do not impede the movement of the moving member 530 along the stator 520.

In this way, when the moving member 530 is moving relative to the stator 520 in the linear movement drive section 700, the braking actuators 536 do not stop the movement of the moving member 530 relative to the stator 520. Furthermore, when the movement of the moving member 530 relative to the stator 520 in the linear movement drive section 700 is stopped, the moving member 530 is fixed relative to the stator 520. Therefore, when the moving member 530 is stopped, it is held in position.

For example, each braking actuator 536 may be formed of a piezoelectric element whose thickness changes when voltage is applied thereto. In other words, a piezoelectric element is used to form each braking actuator 536 with a thickness that decreases when a drive voltage is applied thereto. As a result, when the linear movement drive section 700 is not driving the moving member 530, the braking actuators 536 serve as a braking section that holds the moving member 530 in place.

As a result, when the moving member 530 is not moving in the linear movement drive section 700, the moving member 530 is automatically held at the position where it stopped, without power being supplied. Furthermore, when driving the moving member 530 in the linear movement drive section 700, the drive voltage is applied to the braking actuators 536 in parallel so that the braking actuators 536 no longer operate to brake the moving member 530, and therefore the moving member 530 moves smoothly.

The braking actuators 536 performing the operation described above can be formed of a bimetal that is deformed when heated. As another example, the braking actuator 536 can be formed of a shape memory alloy that returns to the remembered shape when heated to a transition temperature.

The bimetal or shape memory alloy can be combined with a heater, for example, and controlled by turning the power supply ON and OFF. By using the heat generated by the coils 524 to operate the stator 520, the operation of the linear movement drive section 700 is automatically performed simultaneously with the releasing of the brake on the moving member 530 by the braking actuator 536.

In the above example, one end of the holding frame 560 is driven by the moving member 530 and the other end serves as the guided portion 550 that follows on the moving member 530. However, a pair of moving members 530 may be provided such that the holding frame 560 is driven simultaneously at both ends. In this case, it is obvious that a stator 520 is used in place of the guide axle 540.

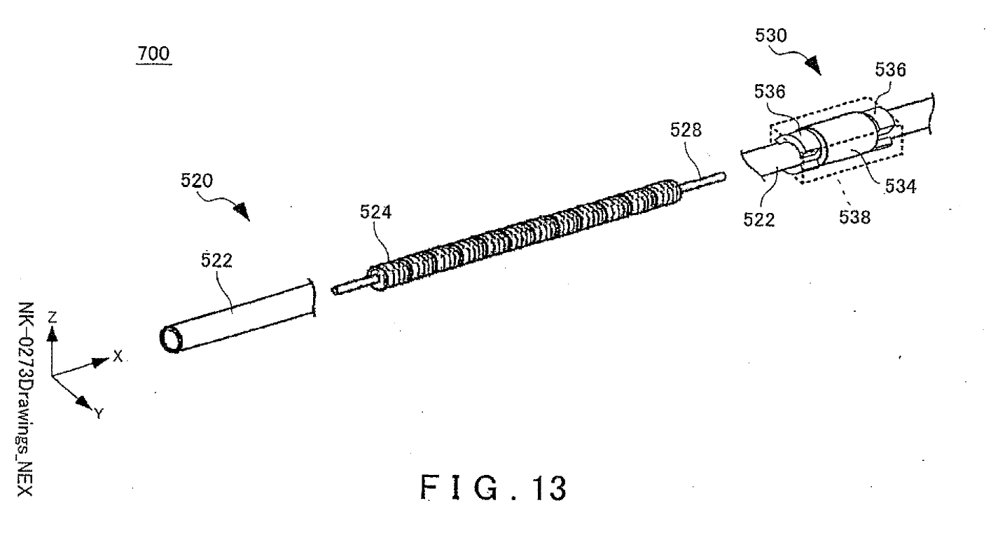

FIG. 13 is a perspective view of the linear movement drive section 700, in which the internal structures of the stator 520 and the moving member 530 are exposed. Components that are the same as components shown in FIGS. 10 to 12 are given the same reference numerals, and redundant descriptions are omitted.

The stator 520 includes the plurality of coils 524 arranged along the core 528. Each coil 524 independently generates a magnetic field when a drive current is applied thereto. In the moving member 530, the permanent magnet 534 surrounds the coils 524 from the outer surface of the outer barrel 522. Furthermore, in the moving member 530, the braking actuators 536 are arranged respectively in front of and behind the permanent magnet 534 in the direction in which the moving member 530 moves.

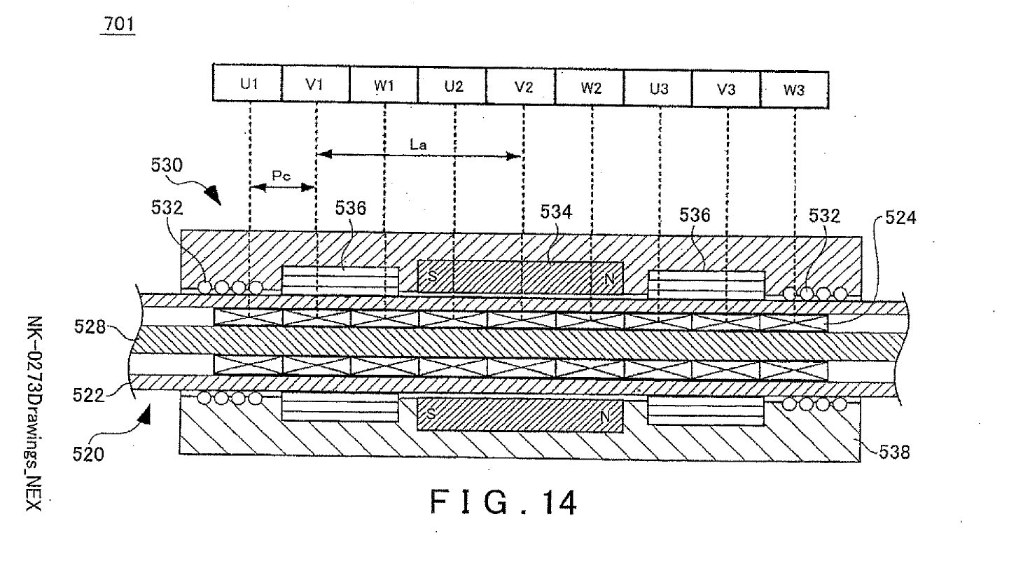

FIG. 14 is a schematic view of the electrical configuration of the linear movement drive section 700. Components that are the same as components shown in other Figures are given the same reference numerals, and redundant descriptions are omitted.

Each coil 524 is independently wrapped around the core 528, and as shown by the dotted lines in FIG. 14, three phases (U, V, and W) are created. In this example, the three phases U, V, and W are used, but it is obvious that the configuration is not limited to three phases, and these phases can be set according to the desired distance over which the moving member 530 is to move. The connections of the coils 524 are not limited to three connections, and the number of phase connections may be two, or greater than three.

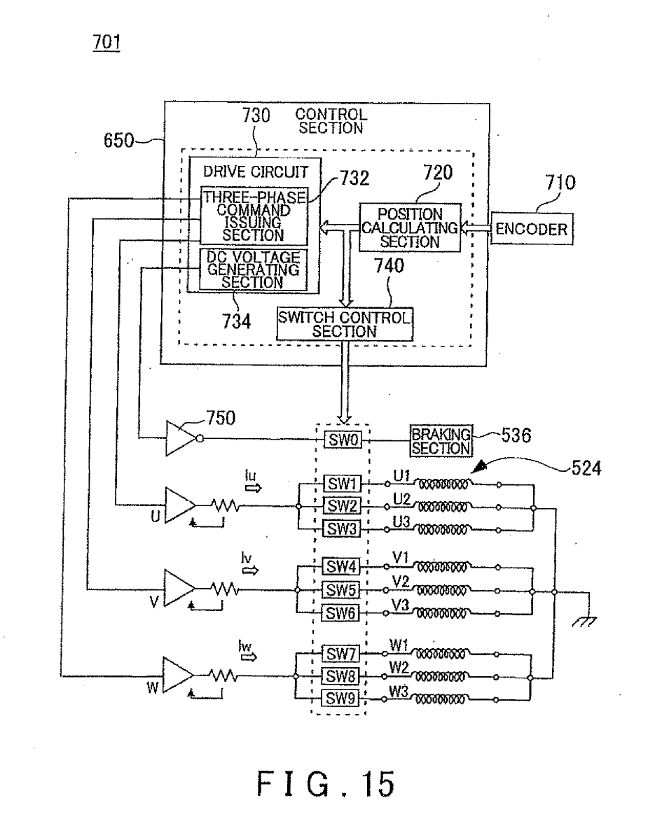

FIG. 15 is a block diagram showing the control system 701 of the linear movement drive section 700. The control system 701 includes a position calculating section 720, a drive circuit 730, and a switch control section 740. The control system 701 is included in the control section 650 of the image capturing section 600.

The position calculating section 720 references the position of the moving member 530 detected by the encoder 710 disposed in the linear movement drive section 700, and turns ON the drive circuit 730 when moving the moving member 530. The drive circuit 730 includes a three-phase command issuing section 732 and a DC voltage generating section 734. The three-phase command issuing section 732 generates a drive current to be supplied to the coils 524. The DC voltage generating section 734 generates the drive voltage to be applied to the braking actuators 536. The switch control section 740 couples the three-phase command issuing section 732 and the DC voltage generating section 734 to the coils 524 or the braking actuators 536 in response to instructions from the position calculating section 720.

When the switch SW0 is connected, the drive voltage of the braking actuator 536 is inverted by the inverting amplifier 750 and applied to the braking actuators 536. As a result, the thickness of each braking actuator 536 decreases and one surface of each braking actuator 536 moves away from the surface of the stator 520. Therefore, the moving member 530 can move smoothly while the drive voltage is supplied to one of the coils 524, as described further below.

Concerning the drive current supplied to the coils 524, when the control section 650 indicates a target position for the moving member 530, the position calculating section 720 references the encoder 710 and calculates a drive amount for the linear movement drive section 700 corresponding to the direction and distance to the target position. The three-phase command issuing section 732 generates the drive current for each of the U-phase, the V-phase, and the W-phase, according to the calculation results, and supplies a three-phase command value to the corresponding current amplifiers.

The switch control section 740 turns a plurality of switches SW1 to SW9 of the switching section S ON and OFF according to the calculation results of the position calculating section 720. In this way, the linear movement drive section 700 can be operated by causing currents Iu, Iv, or Iw to flow through the coils 524. The current amplifiers may be provided with serial resistors that sense excessive current, in order to protect against excessive current.

The supply schedule of the drive current to the coils 524 may be the same as shown in Table 1 above.

By sequentially supplying the drive current to the coils 524 in this way, the moving member 530 on which the permanent magnet 534 is mounted can be moved. Furthermore, by supplying the drive current to the coil 524 in the reverse order, the movement direction of the moving member 530 can be reversed.

Furthermore, while the drive current is being supplied to one of the coils 524, the braking actuators 536 do not perform braking of the moving member 530. Therefore, the moving member 530 receiving this drive force can move smoothly, thereby moving the holding frame 560.

When none of the coils 524 are supplied with the drive current, the switch control section 740 causes all of the switches SW1 to SW9, but not the switch SW0, to be in the connected state. As a result, the linear movement drive section 700 enters a coil short mode, and the linear movement drive section 700 is stopped by the counter electromotive current generated by the relative movement of the permanent magnet 534 and the coils 524.

Furthermore, when none of the coils 524 are supplied with the drive current, the drive voltage causing the braking actuator 536 to release the brake is not supplied thereto. As a result, the braking actuator 536 contacts the moving member 530 and the stator 520, thereby stopping the movement of the moving member 530. This braking is maintained without drive power being received from the outside, and therefore the position at which the moving member 530 is stopped is maintained regardless of whether the power supply is ON or OFF. Furthermore, no power is consumed by stopping the moving member 530.

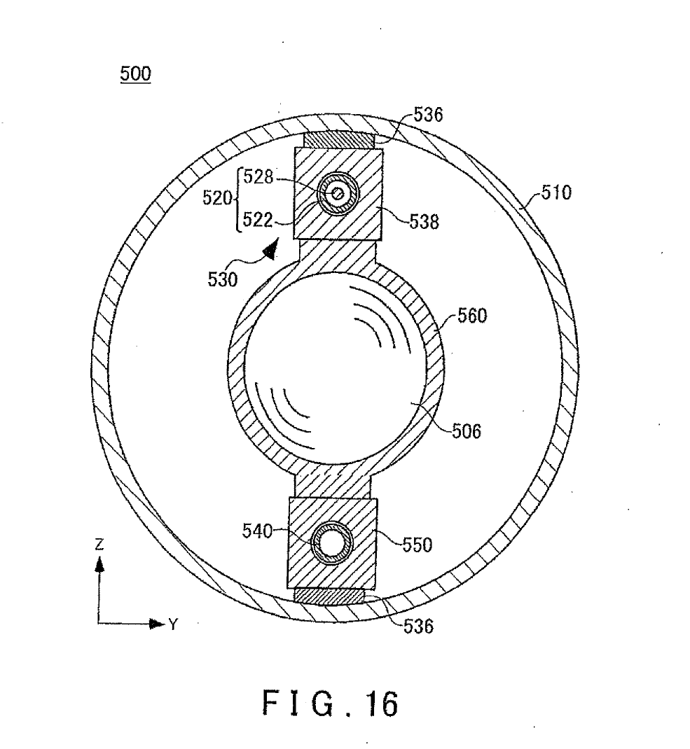

FIG. 16 is a cross-sectional view of another configuration of the lens unit 500. FIG. 16 shows a cross-sectional plane orthogonal to the optical axis C. In FIG. 16, components that are the same as components shown in other Figures are given the same reference numerals, and redundant descriptions are omitted. This lens unit 500 has a unique configuration in which the braking actuators 536 of the moving member 530 are arranged respectively between the moving member body 538 and the lens barrel 510 and between the guided portion 550 and the lens barrel 510.

The braking actuators 536 are the same as the braking actuators 536 described in relation to FIG. 12, and when a drive voltage is not supplied thereto, one surface of each braking actuator 536 is fixed on the moving member body 538 or the guided portion 550 and the other surface presses against the inner surface of the lens barrel 510. As a result, the moving member 530 and the guided portion 550 are pressed against the lens barrel 510 over a large area, thereby stopping the movement of the moving member 530 and the guided portion 550.

When the moving member 530 is to be moved relative to the stator 520, the braking actuators 536 are driven such that the thickness thereof decreases in the radial direction of the lens barrel 510. As a result, the moving member 530 and the guided portion 550 are no longer prevented from moving relative to the lens barrel 510, and can move smoothly along the stator 520 or the guide axle 540.

A piezoelectric element, bimetal, or a shape memory alloy may be used for the braking actuators 536, in the same manner as in the other embodiments. Furthermore, aside from the arrangement of the braking actuators 536, the configurations of the stator 520 and the moving member 530 are the same as in the other embodiments.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A lens unit comprising:
a holding frame that holds a lens;
a movement actuator that moves the holding frame, which is connected to a moving member that moves linearly relative to a stator, when drive force is generated, and does not prevent the moving member from moving relative to the stator when the moving member is stopped; and
a braking actuator that stops the moving member from moving relative to the stator, using frictional force, when the movement actuator is not generating the drive force, and decreases the frictional force when the movement actuator generates the drive force.

2. The lens unit according to claim 1, wherein
the braking actuator includes a piezoelectric element that extends or contracts when voltage is applied thereto.

3. The lens unit according to claim 2, wherein
when the movement actuator is not generating the drive force, the piezoelectric element expands in a manner to press the moving member and the stator against each other and create the frictional force between the moving member and the stator.

4. The lens unit according to claim 2, wherein
when the movement actuator is not generating the drive force, the piezoelectric element contracts in a manner to press the moving member and the stator against each other and create the frictional force between the moving member and the stator.

5. The lens unit according to claim 2, wherein
the braking actuator operates according to power supplied in parallel to the braking actuator and the movement actuator.

6. The lens unit according to claim 1, wherein
the braking actuator includes bimetal that is deformed by heat.

7. The lens unit according to claim 1, wherein
the braking actuator is a shape memory alloy that returns to a memorized shape when heated to a transition temperature.

8. The lens unit according to claim 6, wherein
the braking actuator operates according to heat propagated from the movement actuator.

9. The lens unit according to claim 6, wherein
the braking actuator operates according to a heater that raises the temperature according to power supplied in parallel to the braking actuator and the movement actuator.

10. The lens unit according to claim 1, wherein
the braking actuator includes a control section that, when the movement actuator is not generating the drive force, causes the moving member and the stator to press against each other to generate frictional force between the moving member and the stator.

11. The lens unit according to claim 10, wherein
the control section presses the moving member against the stator using a bias force generated by an elastic component.

12. The lens unit according to claim 1, wherein
the braking actuator includes a control section that, when the movement actuator is not generating the drive force, causes the braking actuator to contact both the moving member and the stator to generate frictional force between the braking actuator and the moving member and between the braking actuator and the stator.

13. The lens unit according to claim 10, wherein
the control section prevents the moving member from moving relative to the stator using a bias force generated by an elastic component.

14. The lens unit according to claim 1, wherein
the direction of the drive force generated by the movement actuator is the direction of an optical axis of the lens, and
the direction of the frictional force generated by the braking actuator includes a component in a direction substantially orthogonal to the optical axis of the lens.

15. An image capturing apparatus comprising the lens unit of claim 1.
